(19) United States
(12) Patent Application Publication
(10) Pub. No.: US 2015/0052069 A1
(43) Pub. Date: Feb. 19, 2015

(54) System And Method For Detecting Fraudulent Purchases And Returns

(71) Applicant: Joseph John Hilo, 1597 Estelle Avenue, NY (US)

(72) Inventor: Joseph John Hilo, 1597 Estelle Avenue, NY (US)

(21) Appl. No.: 14/461,374

(22) Filed: Aug. 16, 2014

Related U.S. Application Data
(60) Provisional application No. 61/959,211, filed on Aug. 19, 2013.

(51) Int. Cl. G06Q 30/00

(52) U.S. Cl. CPC G06Q 30/0185
USPC 705/318

(57) ABSTRACT

A system and method for detecting fraudulent purchases and returns by significantly reducing the amount of loss any store front merchant endures from unforeseen criminal activity. To attain this, the present method generally comprises of opening concealed packages, checking items in packages, re-sealing packages and entering inventory on a computer software system. The re-sealing of packages is preferred to use a custom store logo seal. By opening and checking all incoming items from the beginning of the delivery, upon entering the store, the employees performing this method, begins with the simplest and least obvious means of accounting for inventory. If this step is sufficiently carried thorough, the employees have satisfied the merchant as to the correct quantity and quality of all inventories, when it first comes into the store. Then simply entering items in the computer's inventory software system can be done by an employee, who has only minimal experience of basic word processing, Once opening, checking and entering all incoming items are sufficient the other, more involved, steps must be followed to completion. All steps undertaken must be seen through to completion, for maximum efficacy to reduce the loss of items/money a merchant can endure.

### CROSS-REFERENCE TO RELATED APPLICATIONS

I hereby claim benefit under Title 35, United States Code, Section 119(e) of U.S. Provisional patent application Ser. No. 61/959,211 filed Aug. 19, 2013. The 61/959,211 application is currently pending. The 61/959,211 application is hereby incorporated by reference into this application.

### STATEMENT REGARDING FEDERALLY SPONSORED RESEARCH OR DEVELOPMENT

Not applicable to this application.

### REFERENCE TO SEQUENCE LISTING, A TABLE, OR A COMPUTER PROGRAM LISTING COMPACT DISC APPENDIX

Not applicable to this application.

### BACKGROUND OF THE INVENTION

1. Field of the Method

The present method relates generally to loss prevention and more specifically it relates to loss prevention techniques and systems for merchants to increase profitability.

2. Description of the Related Art

Any discussion of the prior art throughout the specification should in no way be considered as an admission that such prior art is widely known or forms part of common general knowledge in the field.

Merchants have been using surveillance cameras, loss prevention employees and computer inventory software systems for years to prevent and/or catch criminal activity. The problem with these conventional theft prevention methods is they rely solely on expensive surveillance cameras, outdated computer software programs and the naked eye of undercover staff/loss prevention specialist. My method goes an extra step or two, above and beyond to perform in a way that the current cameras, employees and computer inventory systems are not able to. Unfortunately, current surveillance cameras and employees do not have X-ray vision and cannot see through the thick packages that the items are concealed in. Also, their current computer inventory software systems are not accurately updated and lack the crucial management to unlock its fullest potential. These surveillance cameras, employees and computer systems are not equip to catch and/or deter this new breed of thieves. My method will train the merchant's employees on taking the extra steps necessary, to prevent and catch a would be thief, this day in age. In these respects, the system and method for detecting fraudulent purchases and returns according to the present invention substantially departs from the conventional systems and methods of the prior art, and in so doing provides an apparatus primarily developed for the purpose of effectively preventing and catching thieves from stealing items from merchants.

### BRIEF SUMMARY OF THE INVENTION

In view of the forgoing disadvantages inherent in the known types of methods for detecting fraudulent purchases and returns now present in the prior art, the present method provides a new system and method for detecting fraudulent purchases and returns wherein the same can be utilized for effectively preventing and catching thieves. The general purpose of the present method, which will be described subsequently in greater detail, is to provide a new system and method for detecting fraudulent purchases and returns complimenting the systems and methods mentioned heretofore and many novel features that result in a new system and method for detecting fraudulent purchases and returns which is not anticipated, rendered obvious, suggested, or even implied by any of the prior art systems and methods for detecting fraudulent purchases and returns, either alone or in any combination thereof. To attain this, the present method generally comprises of opening concealed packages, checking items in packages, re-sealing packages and entering inventory on a computer software system. The resealing of packages is preferably to use a custom store logo seal. By opening and checking all incoming items from the beginning of the delivery, upon entering the store, the employees performing this method, begins with the simplest and least obvious means of accounting for inventory. If this step is sufficiently carried thorough, the employees have satisfied the merchant as to the correct quantity and quality of all inventories, when it first comes into the store. Then simply entering items in the computer's inventory software system can be done by an employee, who has only minimal experience of basic word processing. Once opening, checking and entering all incoming items is sufficient the other, more involved, steps must be followed to completion. All steps undertaken must be seen through to completion, for maximum efficacy to reduce the loss of items/money a merchant can endure. There has thus been outlined rather broadly, the more important features of the method in order that the detailed description thereof may be better understood, and in order that the present contribution to the art may be better appreciated. There are additional features of the method that will be described hereinafter and that will form the subject matter of the claims appended hereto. In this respect before explaining at least one embodiment of the method in detail, it is to be understood that the method is not limited in its application. The method is capable of other embodiments and of being practiced and carried out in various ways. Also, it is to be understood that the phraseology and terminology employed herein are for the purpose of the description and should not be regarded as limiting. A primary object of the present method is to provide a system and method for detecting fraudulent purchases and returns that will overcome the shortcomings of the prior art devices and techniques. A second object is to provide a system and method for detecting fraudulent purchases and returns that reduces the amount of loss a merchant endures. Another object is to provide a system and method for detecting fraudulent purchases and returns of corrupt employees from stealing from the merchants whom they work for. An additional object is to provide a system and method for detecting fraudulent purchases and returns of corrupt customers from stealing from the merchants whom they shop at. A further object is to provide a system and method for detecting fraudulent purchases and returns by catching thieves from hiding smaller more expensive item in larger, less expensive, packages. Another object is to provide a system and method for detecting fraudulent purchases and returns by preventing customers from trying to swap out and return broken or old/outdated products back to the store concealed in new packages for refunds. A further object is to provide a system and method for detecting fraudulent purchases and returns by preventing individuals from buying deeply discounted or half priced items and trying to return them back to the store to get full price refunds as store credit or gift card. Another object is to provide a system and method for detecting fraudulent purchases and returns by preventing thieves who steal items from one store and try to return them to another stores for store credit or gift cards. A further object is to provide a system and method for detecting fraudulent purchases and returns by holding deliver drivers accountable for each and every item they deliver to and/or from the stores. Other objects and advantages of the present method will become obvious to the reader and it is intended that these objects and advantages are within the scope of the present method. To the accomplishment of the above and related objects, this method may be embodied and that changes may be made in the specific construction illustrated and described within the scope of the appended claims.

### BRIEF DESCRIPTION OF THE SEVERAL VIEWS OF THE DRAWING

Not applicable to this application.

### DETAILED DESCRIPTION OF THE INVENTION

### A. Overview

Even in this day in age with all the “advanced security” that merchants presently have, criminals are still able to steal tangible items without being detected and stay below the radar. This theft not only hurts merchants but consumers as well, who have to make up for the loss with inflated prices. My system & method will detect and prevent the amount of loss a given merchant endures from unforeseen criminal activity by following my specific procedures in conjunction with utilizing existing protocol and computer software the merchant already has set in place. Ultimately, helping the merchant's bottom line, quarter after quarter, year after year. Other prevention methods rely solely on expensive surveillance cameras and the naked eye of undercover staff/loss prevention specialist. My system goes an extra step or two, above and beyond to catch or prevent what the cameras, employees and current computer inventory systems are not able to.

### B. Operation of Method

### Step One

From the point of delivery all items immediately upon entering the store, whenever they have factory seals, employee(s) will open, check and account for the item, then re-seal the item.

### Step Two

Whether store sealed packages or loose, employee(s) will add all items to the merchant's current inventory software system.

### Step Three

When it comes time to bring an item to the area of purchase, employee(s) will again re-open all store sealed packages, check and account for items. At this point, the packages will be re-sealed again by employee(s) with their own “custom” store sealer, before any packages leave the store.

### Step Four

Also, before any item leaves the store, employee(s) will deduct all purchases from the merchant's inventory software system.

### Step Five

Employee(s) will open all returns when applicable, check and account for all items before accepting any items back into the store.

### Step Six

Then, employee(s) will add all returns to the merchant's inventory software system and re-seal any packages, if need be, with their own “custom” store sealer.

### Step Seven

Lastly, only for the customer(s) who cannot produce receipts, the current sale price or lowest price of the item, will go back to the customer in the form of an in store credit. Merchants will award Gift cards or full refunds only for the customer(s) who produce receipts, which proves they paid full price for the item in question.

C. Of the above, Steps 1, 3 and 5 are the simplest methods for preventing and catching a would be thief red handed either trying to put more expensive items in the box or trying to return an outdated/broken item back for a full credit refund. These steps are also the most necessary methods for catching and preventing a would be thief red handed either trying to put more expensive items in the box or trying to return an outdated/broken item back for a full credit refund.

D. Of the above steps 2, 4 and 6 are procedures taken to keep tract of inventory coming in, going out, and if need be, returns back to the store. These steps are also optional procedures that can be taken to keep tract of inventory coming in, going out, and if need be, returns back to the store.

E. Lastly, the above step 7, also necessary, will prevent thieves from getting full prices refunded in the form of a gift cards on items they paid only half price or deep discounts for, This will then prevent thieves from purchasing whatever they wanted from any store within a given chain and stop them in their tracks, from repeating it over and over again.

F. Examples of How to Practice Method

My name is John Doe an employee at XYZ Electronics. We have a new protocol in which I was recently trained on. This is what the new protocol entails and expects of myself and all employees from now on. Let's say I get an incoming items right off the delivery truck such as DVD players, I now have to open the box it comes in, check the item to see if it's there and is in working condition, then re-seal the box with our own store specific tape. Next, I must correctly add the DVD player on XYZ's inventory software system. When this DVD player is being purchased, at the register, the box must be re-opened, DVD player checked to see if it is in fact a DVD player and nothing else hidden, and then reseal the box with our own store specific tape, before it leaves the store. I will then deduct this DVD player from XYZ's inventory software system. in the event the customer shall return this DVD player back to XYZ Electronics, I must open the box check to see if the DVD player is there and in working condition before accepting it back into the store and adding the DVD player back into the inventory software system. Lastly, if the customer doesn't produce a receipt, only the current sale price or lowest price of the DVD player will go back to the customer in the form of an XYZ store credit. From now on, XYZ Electronics will award gift cards or full refunds only for the customer(s) who produce receipts. What has been described and illustrated herein is a preferred embodiment of the method along with some of its variations. The term, descriptions and figures used herein are set forth by way of illustration only and are not meant as limitations. Those skilled in the art will recognize that many variations are possible within the spirit and scope of the method, which is intended to be defined by the following claims (and their equivalents) in which all terms are meant in their broadest reasonable sense unless otherwise indicated. Any heading utilized within the description are for convenience only and have no legal or limiting effect.

I claim:

1. A method for detecting and preventing the amount of loss any store front merchant endures from unforeseen criminal activity comprising the steps of.
(a) From the point of delivery all items immediately upon entering the store, whenever they have factory seals, employee(s) will open, check and account for the item, then re-seal the item with their own “custom” store sealer.
(b) Whether store sealed packages or loose, employee(s) will add all items to the merchant's current inventory software system.
(c) When it comes time to bring an item to the area of purchase, employee(s) will again re-open all store sealed packages, check and account for items. At this point, the packages will be resealed again by employee(s) with their own “custom” store sealer before any packages leave the store.
(d) Also, before any item leaves the store, employee(s) will deduct all purchases from the merchant's inventory software system.
(e) Employee(s) will open all returns when applicable, check and account for all items before accepting any items back into the store.
(f) Then, employee(s) will add all returns to the merchant's inventory software system and reseal any packages, if need be, with their own “custom” store sealer.
(g) Lastly, only for the customer(s) who cannot produce receipts, the current sale price or lowest price of the item, will go back to the customer in the form of an in store credit. Merchants will award Gift cards or full refunds only for the customer(s) who produce receipts.

2. The method of claim 1 further comprising as an upgrade/improvement, by packaging all merchandise in clear packages, so that it will be easier to see exactly what is coming in and out of the stores without having to open, seal and/or re-seal packages.
